(19) United States
(12) Patent Application Publication
(10) Pub. No.: US 2004/0105143 A1
(43) Pub. Date: Jun. 3, 2004

(54) BROADBAND LIGHT SOURCE DEVICE

(75) Inventors: Jyh Chain Lin, Tu-Chen (TW); Kun-Jung Tsai, Tu-Chen (TW)

Correspondence Address: WEI TE CHUNG, FOXCONN INTERNATIONAL, INC., 1650 MEMOREX DRIVE, SANTA CLARA, CA, 95050, US

(73) Assignee: HON HAI PRECISION IND. CO., LTD, Tu-Chen (TW)

(21) Appl. No.: 10/707,161

(22) Filed: Nov. 24, 2003

(30) Foreign Application Priority Data
Nov. 2, 2002 (TW) 91218814

(51) Int. Cl. H01S 3/00

(52) U.S. Cl. 359/341.3

(57) ABSTRACT

A broadband light source (200) includes a pump laser (20), a lanthanide series element-doped fiber (22) having a predetermined length, a WDM device (21) with at least three ports, and first and second optical isolators (23, 28). Two ports (26, 29) of the WDM device respectively connect with the laser and the fiber. The first isolator connects with a third port of the WDM device. The second isolator connects with the fiber. The first and second isolators are located in an output passing of the source for reducing reflection of output light. Pump light is coupled to the fiber by the WDM device, and is amplified by the fiber. A part of the amplified light passes the second isolator and is exported. A remaining part of the amplified light is coupled to the first isolator by the WDM device, and is exported via an output end of the first isolator.

### BACKGROUND OF INVENTION

1. Field of the Invention

The present invention relates to broadband light source devices, and particularly to an amplified spontaneous emission (ASE) light source.

2. Description of Related Art

An ASE light source is a kind of broadband source with high stability and power. The ASE light source is widely used in testing optical communication systems such as DWDM (Dense Wavelength Division Multiplexing) systems, and optical passive devices such as fiber gratings, DWDM film filters, CWDM (Coarse Wavelength Division Multiplexing) film filters and plane AWGs (Arrayed Waveguide Gratings).

Referring to FIG. 3, basic infrastructure of a conventional broadband light source device is illustrated. The broadband light source device has a pump laser 101 with a laser diode, the laser diode emitting light having a wavelength of 980 nm. The emitted light is coupled to an erbium-doped fiber 103 by a WDM device 102, and excites erbium ions of the erbium-doped fiber 103 to produce a broadband light source having a wavelength of 1550 nm. The light source could be exported via a first end and second end. However, output power of the first and second ends corresponds to the length of the erbium-doped fiber 103. With an increase in length of the erbium-doped fiber 103, the output power of the first end gradually increases until it approaches a saturation value. With the increase in length of the erbium-doped fiber 103, the output power of the second end increases to a maximum value at which the erbium-doped fiber 103 has a specific length. Thereafter, the output power of the second end gradually decreases until it approaches a value of zero. The maximum value of the first end or second end can be obtained by configuring an appropriate length of the erbium-doped fiber 103. Since a part of the 1550 nm wavelength light may be reflected back to the light source, this reflected light should be reduced as much as possible, in order to avoid stimulated emission of radiation and thereby maintain the bandwidth of the output light.

Conventional broadband light source devices commonly use one end as the output end, so as to obtain maximum optical output power of the end and also maintain bandwidth. However, the output power of the other end is wasted.

Referring to FIG. 4, U.S. Pat. No. 6,429,965 discloses a broadband light source 100. The broadband light source 100 includes a pump laser 10, a WDM device 11, an erbium-doped fiber 12, and an optical isolator 13. The pump laser 10 generally is a laser diode emitting light having a wavelength of 980 nm. A length of the erbium-doped fiber 12 is a minimum value which provides output power of a first output port that is a saturated value. The pump laser 10 connects with the WDM device 11 via an output fiber 14. The WDM device 11 connects with the erbium-doped fiber 12 and an input fiber 15 of the optical isolator 13. The optical isolator 13 has a pigtail as a first output fiber 16, which provides the first output port of the broadband light source 100. A second output fiber 17 connecting with the erbium-doped fiber 12 has a coarse end face so as to reduce reflection and improve optical performance.

However, the broadband light source 100 must use an optical coupler connecting with the first output fiber 16 in order to achieve double-port output.

### SUMMARY OF INVENTION

Accordingly, an object of the present invention is to provide a broadband light source that can efficiently achieve double bandwidth output.

In order to achieve the object set out above, a broadband light source in accordance with the present invention includes a pump laser for producing a pump light, a lanthanide series element-doped fiber with a predetermined length which can achieve light amplification by stimulated radiation, a wavelength division multiplexer (WDM) device with at least three ports, and first and second optical isolators. Two ports of the WDM device respectively connect with the pump laser and the fiber. The first optical isolator connects with a third port of the WDM device. The second optical isolator connects with the fiber. The first and second optical isolators are located in an output passing of the broadband light source for reducing reflection of output light. The pump light is coupled to the fiber by the WDM device. The pump light is amplified by the fiber. A part of the amplified light passes the second optical isolator and is exported. A remaining part of the amplified light which is coupled to the first isolator by the WDM device is exported via an output end of the first isolator.

Other objects, advantages and novel features of the invention will become more apparent from the following detailed description when taken in conjunction with the accompanying drawings, in which:

### BRIEF DESCRIPTION OF DRAWINGS

FIG. 1 is a schematic view of a conventional broadband light source;

FIG. 2 is a schematic view of another conventional broadband light source;

FIG. 3 is a schematic view of a broadband light source in accordance with the present invention; and

FIG. 4 is a graph showing a relationship between output power and a length of an erbium-doped fiber of the broadband light source of FIG. 3.

### DETAILED DESCRIPTION

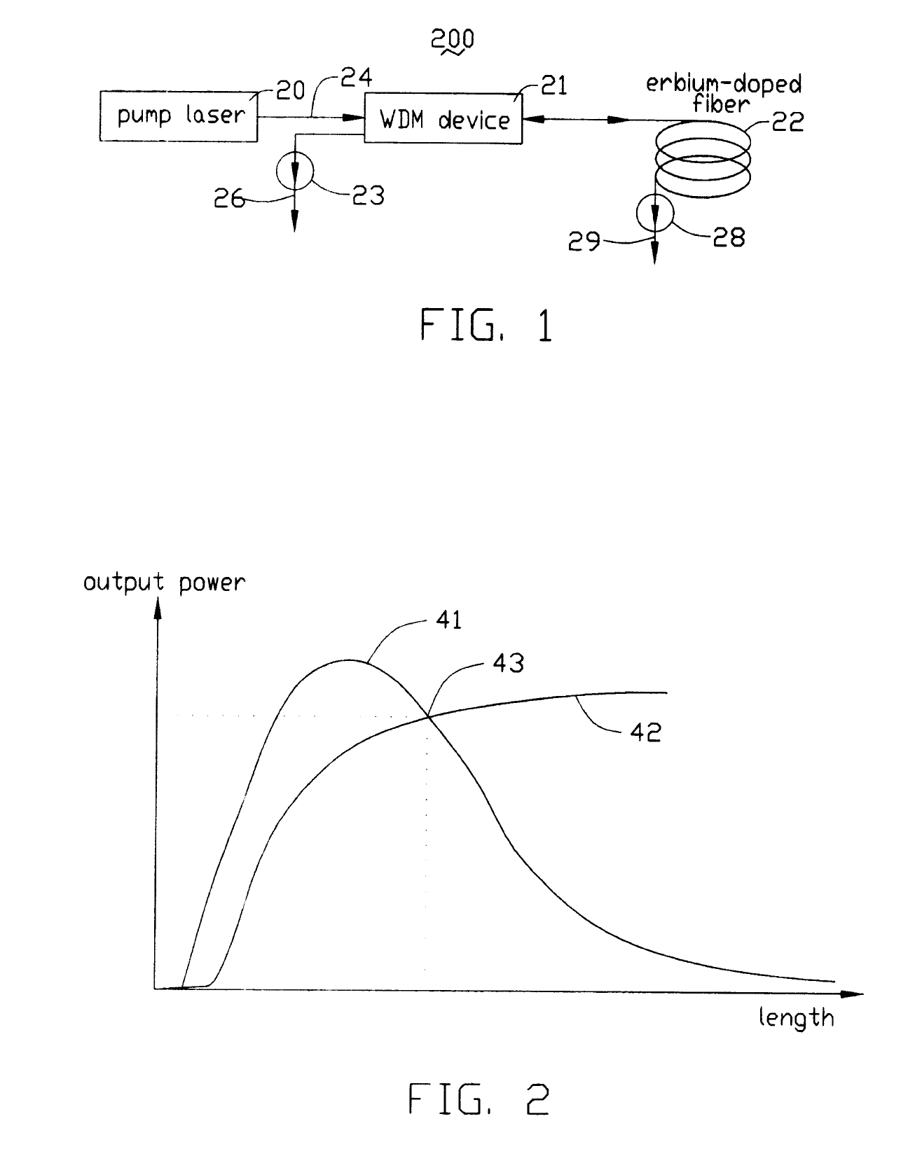

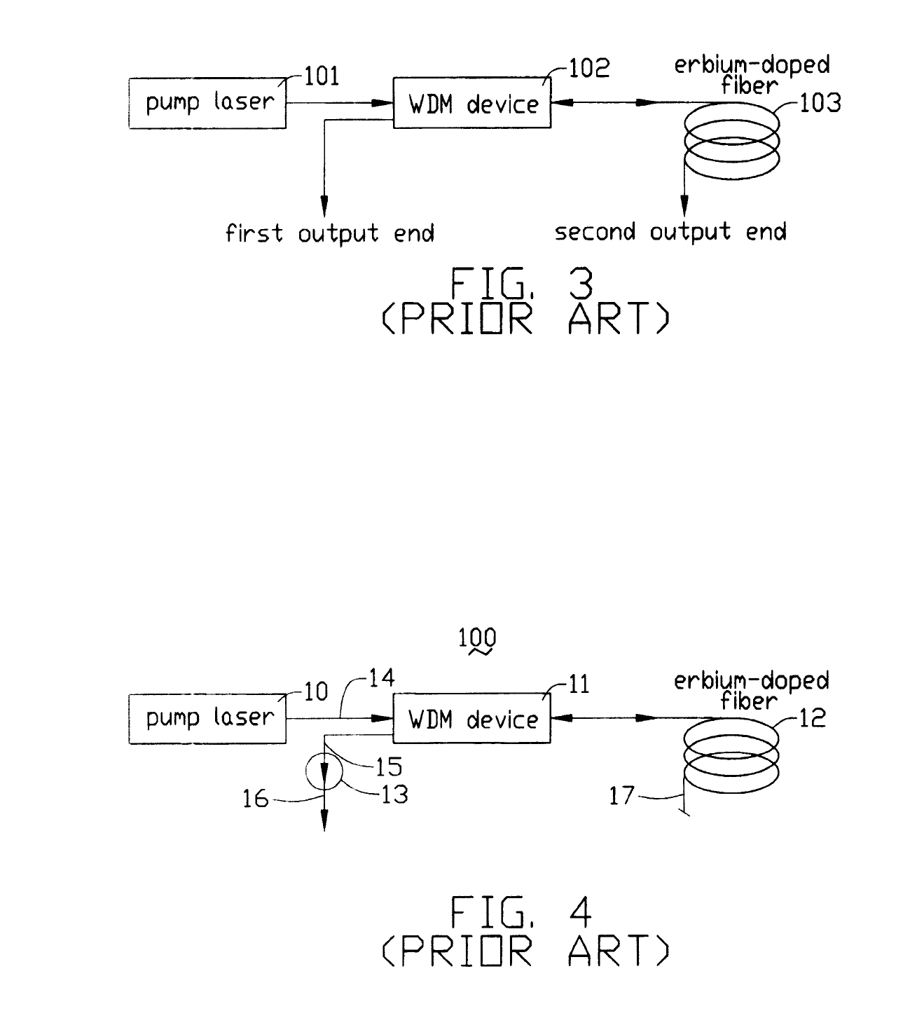

Referring to FIG. 1, a broadband light source 200 of the present invention comprises a pump laser 20, a WDM device 21 which has at least three ports, an erbium-doped fiber 22 having a predetermined length, first and second optical isolators 23, 28, and first and second output ends 26, 29. The pump laser 20 is generally a laser diode emitting light having a wavelength of 980 nm. Two ports of the WDM device 21 respectively connect with the pump laser 20 and the erbium-doped fiber 22. The light emitted by the pump laser 20 is transmitted into the erbium-doped fiber 22 by the WDM device 21, and a spontaneous-radiation light of the erbium-doped fiber 22 is transmitted to a third port of the WDM device 21. The third port of the WDM device 21 connects with an input end of the first optical isolator 23, and an output end of the first optical isolator 23 is the first output end 26. The second optical isolator 28 connects with the erbium-doped fiber 22. The first and second optical isolators 23, 28 are respectively adjacent to the first and second output ends 26, 29 of the broadband light source 200. This reduces reflection of output light and maintains a bandwidth of the broadband light source 200 free from the effects of oscillation of the output light between the two output ends 26, 29.

FIG. 2 shows a relationship between output power of the broadband light source 200 and a length of the erbium-doped fiber 22. The curve 41 indicates a relationship between output power of the second output end 29 and the length of the erbium-doped fiber 22. Initially, the output power gradually increases with increasing length. However, when the length reaches a threshold value, the output power gradually decreases with increasing length until the output power approaches a value of zero. The curve 42 indicates a relationship between output power of the first output end 26 and the length of the erbium-doped fiber 22. The output power gradually increases with increasing length until the output power approaches a saturation value. The curves 41 and 42 intersect at a point 43. The output power of the first output end 26 is identical to the output power of the second output end 29 at the point 43, and the predetermined length of the erbium-doped fiber 22 corresponds to the point 43.

Operation of the broadband light source 200 is as follows. The pump laser 20 emits a pump light having a wavelength of 980 nm, which is transmitted to the WDM device 21 by the output fiber 24. Then the pump light is coupled to the erbium-doped fiber 22 by the WDM device 21. The pump light excites the erbium-doped fiber 22 to produce broadband light having a wavelength of 1550 nm. A part of the 1550 nm wavelength light passes through the second optical isolator 28 and is exported via the second output end 29. A remaining part of the 1550 nm wavelength light is coupled to the WDM device 21, transmitted to the first optical isolator 23, and exported via the first output end 26. The power of the light output to the first output end 26 is identical to the power of the light exported from the second output end 29.

The length of the erbium-doped fiber 22 is a specific value at which the power of the first output end 26 is same as the power of the second output end 29. Accordingly, the broadband light source 200 of the present invention can achieve double bandwidth output and minimize power loss.

It is noted that the erbium-doped fiber 22 of the present invention can be replaced by other lanthanide series element-doped fiber that can achieve light amplification by stimulated radiation. For example, a praseodymium-doped fiber can be used.

While the present invention has been described with reference to particular embodiments, the description is illustrative of the invention and is not to be construed as limiting the invention. Therefore, various modifications to the present invention can be made to the preferred embodiments by those skilled in the art without departing from the true spirit and scope of the invention as defined by the appended claims.

1. A broadband light source comprising:
a pump laser for producing a pump light;
a lanthanide series element-doped fiber having a predetermined length which can achieve light amplification by stimulated radiation;
a wavelength division multiplexer (WDM) device with at least three ports, first and second ports of said three ports respectively connecting with the pump laser and said fiber; and
a first optical isolator and a second optical isolator, the first optical isolator connecting with a third port of the WDM device, the second optical isolator connecting with said fiber, the first and second optical isolators being located in an output passing of the broadband light source for reducing reflection of output light;
wherein the pump light is coupled to said fiber by the WDM device, the pump light is amplified by said fiber, a part of the amplified light passes the second optical isolator and is exported, and a remaining part of the amplified light is coupled to the first isolator by the WDM device and is exported via an output end of the first isolator.

2. The broadband light source as described in claim 1, wherein said fiber is an erbium-doped fiber.

3. The broadband light source as described in claim 2, wherein the erbium-doped fiber's predetermined length is such that the first and second optical isolators can achieve a same output optical power.

4. The broadband light source as described in claim 1, wherein said fiber's predetermined length is such that the first and second optical isolators can achieve a same output optical power.

5. The broadband light source as described in claim 1, wherein the pump laser comprises a laser diode emitting light having a wavelength of 980 nm.

6. A broadband light source comprising:
a pump laser for producing a pump light;
an erbium-doped fiber having a predetermined length;
a wavelength division multiplexer (WDM) device with at least three ports, first and second ports of said three ports respectively connecting with the pump laser and the erbium-doped fiber;
a first optical isolator and a second optical isolator, the first optical isolator connecting with a third port of the WDM device, the second optical isolator connecting with the erbium-doped fiber, the first and second optical isolators being located in an output passing of the broadband light source for reducing reflection of output light;
wherein the pump light is coupled to the erbium-doped fiber by the WDM device, the pump light is amplified by the erbium-doped fiber, a part of the amplified light passes the second optical isolator and is exported, and a remainder of the amplified light is coupled to the first isolator by the WDM device and is exported via an output end of the first isolator.

7. The broadband light source as described in claim 6, wherein a component which is adapted to be connected to the output end of the first isolator, is not a coupler.
